(19) United States
(12) Patent Application Publication
(10) Pub. No.: US 2024/0364036 A1
(43) Pub. Date: Oct. 31, 2024

(54) Contact Assembly for Electrical HV Connections

(71) Applicant: TE Connectivity Solutions GmbH, Schaffhausen (CH)

(72) Inventors: Martin JUNGNICKEL, Woert (DE); Andre MAIROSER, Woert (DE); Alexander RUDI, Woert (DE); Stefan RAAB, Woert (DE)

(73) Assignee: TE Connectivity Solutions GmbH, Schaffhausen (CH)

(21) Appl. No.: 18/645,438

(22) Filed: Apr. 25, 2024

(30) Foreign Application Priority Data
Apr. 28, 2023 (DE) 102023111126.4

(51) Int. Cl. H01R 13/24; H01R 13/44; H01R 13/514

(52) U.S. Cl. CPC H01R 13/24; H01R 13/44; H01R 13/514

(57) ABSTRACT

The invention relates to a contact assembly for electrical HV connections, having a housing with touch protection which has a through-opening extending from a first housing end of the housing to a second housing end of the housing which is spaced apart from the first housing end along an axial direction, wherein the housing has at least one radially inwardly protruding touch protection element at the second housing end and, has in the through opening, at least one latching surface extending in a circumferential direction around the axial direction which has a surface normal directed towards the second housing end, having a contact element which can be inserted from the first housing end into the through-opening towards the second housing end in any desired angular position around the axial direction, wherein at least one latching protrusion of the contact element latches with the at least one latching surface in each of the desired angular positions when the contact element is inserted into the through-opening. The contact assembly according to the invention has a touch protection and is nevertheless easy to assemble.

This application claims priority to and the benefit of German Patent Application No. 102023111126.4 filed Apr. 28, 2023, which is hereby incorporated by reference in its entirety.

The invention relates to a contact assembly for electrical HV connections.

Contact assemblies are used in particular in the field of electrical engineering to make electrical connections in the high-voltage (HV) range. Such a contact assembly can be part of an electrical plug connector, for example.

Contact assemblies usually provide a contact element that can be inserted into a-usually electrically insulating-housing and latched to it. Contact assemblies for high-voltage or high-current connections usually have touch protection to prevent a human finger from being inserted into the housing and coming into contact with current-carrying components of the contact assembly. Such touch protection makes the installation process more difficult.

The invention is intended to provide a contact assembly which has touch protection and is nevertheless easy to install.

According to the invention, this is achieved by a contact assembly for electrical HV connections
having a housing with touch protection, which has a through-opening extending from a first housing end of the housing to a second housing end of the housing which is spaced apart from the first housing end along an axial direction,
wherein the housing has at least one radially inwardly protruding touch protection element at the second housing end; and
has in the through-opening at least one latching surface extending in a circumferential direction around the axial direction which has a surface normal directed towards the second housing end; and
having a contact element which can be inserted from the first housing end into the through-opening towards the second housing end in any desired angular position around the axial direction,
wherein at least one latching protrusion of the contact element latches with the at least one latching surface in each of the desired angular positions when the contact element is inserted into the through-opening.

The touch protection prevents a human finger or any other object not belonging to the contact assembly from passing through a radial plane in which the touch protection is arranged along an insertion direction. This is realized by the fact that the at least one radially inwardly protruding touch protection element of the touch protection reduces the through-opening at the point of the radial plane, that is, reduces the diameter of the through-opening. The touch protection elements are adapted such that they reduce the diameter of the through-opening at the point of the radial plane to such an extent that a human finger cannot be pushed through in the axial direction. A human finger or object, the diameter of which is small enough to be inserted into the through-opening of the housing but too large to pass through the touch protection in the axial direction, is therefore prevented from reaching current-carrying components. Beyond the second housing end, for example, current-carrying components can be arranged with which a human finger or another object that is not part of the contact assembly must not come into contact under any circumstances for safety reasons. The touch protection prevents this and consequently increases the safety of use of the contact assembly.

In particular, the touch protection can comply with the specifications of the ISO 20653 standard. Contact with the current-carrying components can be prevented by a human finger of a user simulated, for example, by a test finger in accordance with the usual standards, for example DIN EN 60529: 2000, which specifies a length of 80 mm and a diameter of 12 mm for the test finger. Other relevant standards may be: VDE 0470 Part 2, IEC/EN 61032, VDE 0470 Part or IEC/EN 60529, IEC/EN 60950, IEC 61010, IEC/EN 60335, IEC/EN 60745-1, IEC/EN 60034-5 and IEC/EN 60065.

The provision of at least one latching surface in the housing and at least one latching protrusion on the contact element forms the structural prerequisite for a form-fit connection between the latching surfaces and the latching protrusions. In this way, a contact element inserted into the through-opening can be latched to the housing in a form-fitting manner and secured there. This can prevent or at least limit relative movement between the contact element and the housing in the axial direction. In particular, such a latching prevents or limits movement of the contact element in the opposite direction to the direction of insertion. In this way, unintentional loosening of the contact assembly is prevented, resulting in a more stable electrical connection.

The contact assembly according to the invention also has the advantage of enabling polarizationfree insertion of a contact element into the housing. The contact element can be inserted into the through-opening in any angular position around the axial direction relative to the housing. The rotation in the circumferential direction of the contact element relative to the housing is irrelevant for both insertion and latching. Since the contact element does not have to be aligned relative to the housing in the circumferential direction, but only the longitudinal axes of the contact element and the through-opening have to be flush, assembly is simplified.

If the contact element is connected to a cable, twisting and therefore potential damage to the cable can be prevented. This is due to the fact that the contact element can follow the rotation of the cable around its longitudinal axis, which counteracts harmful twisting. This also applies when the contact element is latched inside the housing, as the contact element can rotate freely relative to the housing along the circumferential direction.

If the contact element is inserted into the through-opening of the housing, at least one latching protrusion latches with at least one latching surface, regardless of the angular position around the axial direction of the contact element relative to the housing. A contact element inserted into the through-opening can therefore rotate freely along the circumferential direction relative to the housing without the latching between the contact element and the housing being released. Such polarization-free latching ensures that the contact assembly remains functional even when the contact element moves in the circumferential direction relative to the housing. This increases, for example, the stability and safety of an electrical connection established by the contact assembly.

The above invention can be further improved by the following features, each of which is preferred and can be combined with one another as desired.

According to a further preferred embodiment, the through-opening can have a plurality of latching surfaces spaced apart from one another in the circumferential direction and the contact element can have a plurality of latching protrusions arranged next to one another in the circumferential direction and, with the contact element latched inside the housing, at least one latching protrusion can abut against a latching surface over its entire width extending in the circumferential direction in each angular position of the contact element relative to the housing.

According to a further preferred embodiment, the through-opening can have a plurality of latching surfaces spaced apart from one another in the circumferential direction and the contact element can have a plurality of latching protrusions arranged next to one another in the circumferential direction and, with the contact element latched inside the housing, at least one latching protrusion can abut against a latching surface over its entire width extending in the circumferential direction in each angular position of the contact element relative to the housing.

According to a further aspect, the latching surfaces and the latching protrusions may have at least one of the following differences:
the width in the circumferential direction of at least some of the plurality of latching surfaces differs from the width in the circumferential direction of at least some of the plurality of latching protrusions;
the number of latching surfaces differs from the number of latching protrusions;
the distance in the circumferential direction between at least some latching protrusions of the plurality of latching protrusions, the at least some latching protrusions being adjacent in the circumferential direction, differs from the distance in the circumferential direction between at least some touch protection elements adjacent in the circumferential direction.

These geometric or numerical ratios between latching surfaces and latching protrusions can be used to adjust the area overlap between latching surfaces and latching protrusions to the respective application. In this context, for example, the overlap that is required for a certain latching force can be ensured.

In one configuration, the at least one touch protection element forms a stop against which the contact element strikes when it is inserted into the housing, in particular when the contact element is fully inserted into the housing. In this way, movement of the contact element relative to the housing along the direction of insertion is limited. If the contact element is fully inserted into the housing and the latching protrusions are latched with the latching surfaces, the movement of the contact element relative to the housing against the direction of insertion is also limited. As a result, the contact element is secured against movement along the axial direction and interruption of the electrical contact of the contact assembly, in particular due to the contact element slipping out or a loose contact, is prevented. Such a contact assembly increases the stability of an electrical connection.

The majority of the latching surfaces can lie in a common plane that runs perpendicular to the axial direction. Analogously, the majority of the latching protrusions can also lie in a common plane that is perpendicular to the axial direction.

Both the latching surfaces and the latching protrusions can have the same width in the circumferential direction. Preferably, several latching protrusions of the plurality of latching protrusions can each abut against a latching surface over their entire width extending in the circumferential direction. In particular, the latching protrusions can each abut a different latching surface.

The cross-sectional area of a touch protection element can become smaller inwards in the radial direction. A touch protection element can have its largest cross-sectional area at a point that is furthest away from the center axis of the housing in the radial direction. Analogously, a touch protection element can have its smallest cross-sectional area at a point that is spaced apart closest from the center axis of the housing in the radial direction.

Preferably, the touch protection elements can have a ramp on their end face pointing away from the first housing end. In particular, the ramp can be inclined inwards in the radial direction towards the first housing end in relation to the axial direction. The ramp can be planar, for example, or curved, for example as part of a cylinder stub shell surface.

According to a further preferred embodiment, touch protection elements of the plurality of touch protection elements adjacent to each other in the circumferential direction may be separated from each other by one gap each; and at least some of the plurality of latching surfaces may be located in the axial direction in extension of at least one gap each. Preferably, the plurality of latching surfaces can be located in the axial direction in the extension of at least one gap in each case. The gaps and the latching surfaces can be flush in the axial direction.

The gaps arranged in the circumferential direction between the touch protection elements represent a manufacturing advantage within the injection molding process. Parts of the injection mold can be easily inserted into the housing to be molded along the axial direction and the latching surfaces can be formed.

According to a further preferred embodiment, the width of a latching surface in the circumferential direction can be at most as large as the width of the gap in the circumferential direction. Alternatively, the width of the latching surfaces in the circumferential direction can also be as large or larger than the distance between two adjacent touch protection elements in the circumferential direction. Such a configuration is easy to produce, for example, as part of an injection molding process. In this process, injection molding tools can be inserted into the housing via the gaps in order to form the latching surfaces. A contact assembly according to this embodiment is preferred in terms of production technology.

According to a further aspect of the invention, at least one latching protrusion of the plurality of latching protrusions can be latched with at least two latching surfaces when the contact element is inserted into the housing. In the event of a force acting on the contact element in the axial direction, the mechanical load between the at least one latching protrusion and the latching surfaces is distributed over the at least two latching surfaces, which reduces the material load on the latching surfaces. In addition, a contact element is latched redundantly according to this embodiment. This increases the operational reliability of the contact assembly.

According to a further embodiment, a latching surface can form the end of a base extending in the axial direction from the first to the second housing end pointing towards the second housing end. This configuration reduces the mechanical load on the housing and the latching surfaces, as the mechanical stresses occurring between the latching protrusions and the latching surfaces are introduced evenly into the base body. This has a positive effect on the service life of the contact assembly.

The base can have the shape of a hollow cylinder segment. The ground area of the base can extend along the axial direction and the circumferential direction and the base can protrude in the radial direction.

Furthermore, the bases can be formed by the wall of the through-opening. Such a configuration simplifies production, especially as part of an injection molding process. This reduces the manufacturing costs.

According to a further embodiment of the invention, the base can be flush in the axial direction with a gap between two touch protection elements adjacent in the circumferential direction. During an injection molding process, sliders can thus be inserted into the housing via the gaps at the second housing end in order to be able to mold the bases. This simplifies the manufacturing process.

The base can be configured such that it is not wider at any point in the circumferential direction than the gaps flush with it between the two touch protection elements adjacent to it in the circumferential direction. In addition, the base can be arranged such that it does not overlap a touch protection element at any point in the axial direction. In particular, the distance in the axial direction between the end of the base facing the first housing end and the end of the base facing the second housing end can be less than or equal to the distance in the axial direction between the end of the base facing the first housing end and a side surface of the touch protection element facing the first housing end.

According to a further aspect, the housing can have a plurality of bases and bases adjacent to one another in the circumferential direction can be separated from one another by a recess. The recess can extend continuously in the axial direction at least from the latching surface to the first housing end.

During production as part of the injection molding process, a slider extending to the touch protection elements can be inserted along the axial direction via the recess, which considerably simplifies mold making.

According to another preferred embodiment, an annular depression can be located between the bases and the second housing end. The annular depression forms the structural prerequisite for the contact element to be able to latch with a latching surface in any angular position in the circumferential direction relative to the housing. A latching protrusion can only make contact with a latching surface in a form-fit manner if the latching protrusions and the latching surfaces overlap in the radial direction. When the contact element is inserted along the insertion direction, the latching protrusions are initially deflected inwards or elastically deformed by the bases in the radial direction. To enable the latching protrusions to overlap with the latching surfaces, the latching protrusions must be able to move outwards again in the radial direction in a snap-in movement after passing over the bases along the axial direction. This is possible if a depression extending in the axial direction between the bases and the touch protection elements is provided, which can accommodate the latching protrusions. The preferably provided annular depression has the advantage that the latching protrusions can move outwards in the radial direction at any point along the circumferential direction after passing over the bases. In addition, an annular depression is easy to produce in terms of production technology-for example as part of an injection molding process-and cost-effective.

The recesses in the circumferential direction of adjacent bases can merge into the depression. In particular, the recesses can merge into the depression without jumping. In this case, a radial offset between the recess and the depression can be zero at the point in the axial direction at which a recess merges into a depression.

In addition, the depression can extend between the touch protection elements. In this case, a radial offset can be zero at the point in the axial direction at which a depression merges into the area extending along the axial direction and the circumferential direction between two adjacent touch protection elements.

A jump-free transition between the recesses, the depression and the areas between adjacent touch protection elements has the advantage of being easy to manufacture, especially as part of an injection molding process.

According to a further preferred embodiment, the latching surface can be formed by the end of a rebound pointing towards the first housing end, which extends in the axial direction from the housing surface to between two adjacent touch protection elements. Alternatively, the rebound can also spring back in the radial direction. Such a configuration is preferred in terms of production technology because the rebounds are easily accessible for tools via the second housing end. The rebounds can therefore be manufactured easily and cost-effectively.

According to a further embodiment, rebounds adjacent to each other in the circumferential direction can be separated from each other by a protrusion and the protrusion can extend in the axial direction from a latching surface to a touch protection element. In this embodiment, the movement in the circumferential direction of a contact element latched in the through-opening is limited, as the latching protrusions of the contact element are adjoining the side surfaces of adjacent protrusions in the latched state. This prevents or limits a relative movement in the circumferential direction between the contact element and the wall of the through-opening, which results in less wear of the contact element and the wall of the through-opening.

The protrusion can protrude inwards in the radial direction. Furthermore, a protrusion can extend in the axial direction in the shadow of the touch protection element at which the protrusion ends.

In particular, the protrusions between the rebounds in the axial direction towards the first housing end can be united in the circumferential direction from the latching surfaces to form an annular protrusion. In particular, the annular protrusion can extend in the axial direction from the latching surfaces to the first housing end.

In a further aspect, the width of the latching protrusions in the circumferential direction can be smaller than the width of the latching surfaces in the circumferential direction. Such a ratio between the widths of the latching protrusions and the widths of the latching surfaces increases the probability that a latching protrusion abuts against a latching surface over its entire width. In this way, the material load on the latching protrusions can be reduced.

In particular, the width of two latching protrusions adjacent in the circumferential direction, including an optional gap between the two latching protrusions, can be at most as large as the width in the circumferential direction of the latching surfaces.

According to one possible embodiment, the housing can be made by injection molding. In this way, the housing and thus the contact assembly can be manufactured cost-effectively as part of automated production.

In the following, the invention is explained in more detail by means of embodiments with reference to the attached Figures. In this context, individual features present in an embodiment below may be omitted if, according to the above embodiments, the technical effect associated with this feature is not important. Conversely, a feature described above but not present in an embodiment below can be added to the embodiment if the technical effect associated with this feature is important for a particular application.

In the following, the same reference signs are used for elements that correspond to each other in terms of structure and/or function.

It is shown by:

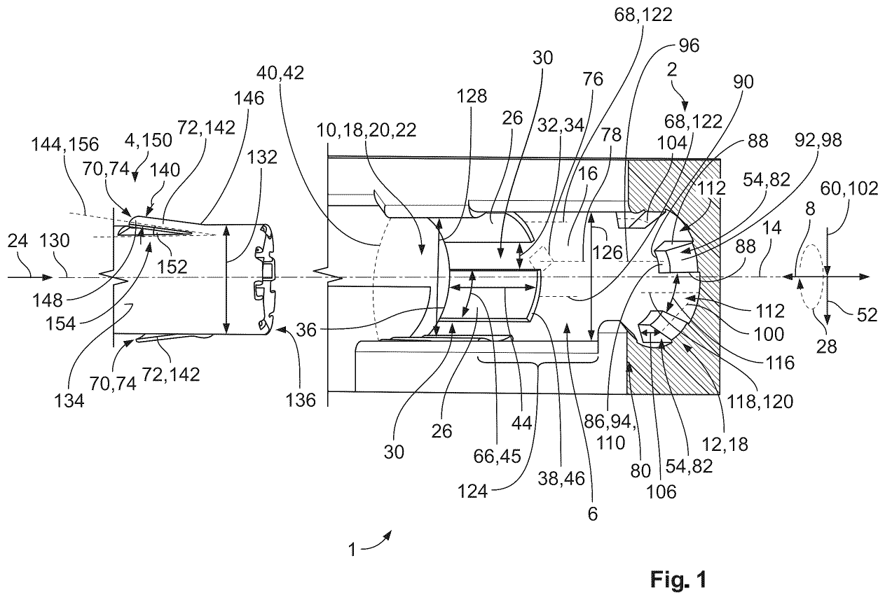

FIG. 1 a schematic perspective view of a contact assembly according to a possible embodiment;

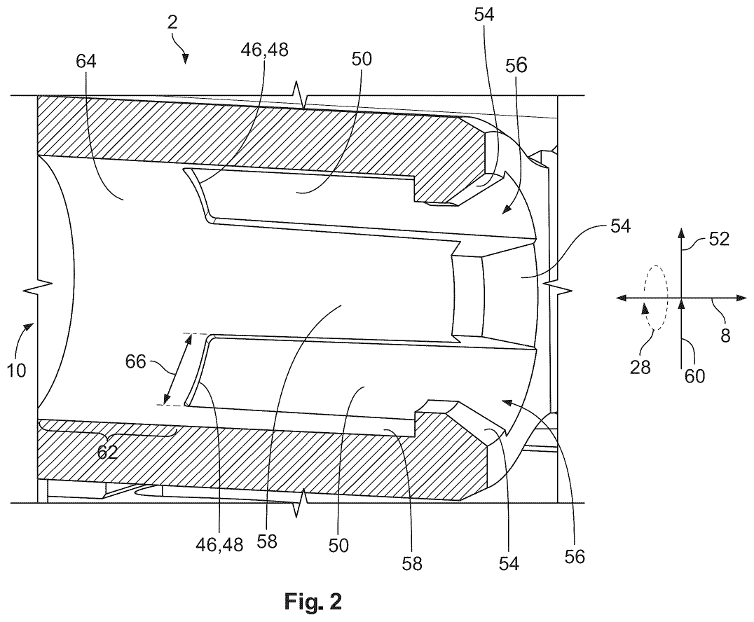

FIG. 2 a schematic perspective view of a housing according to a possible embodiment;

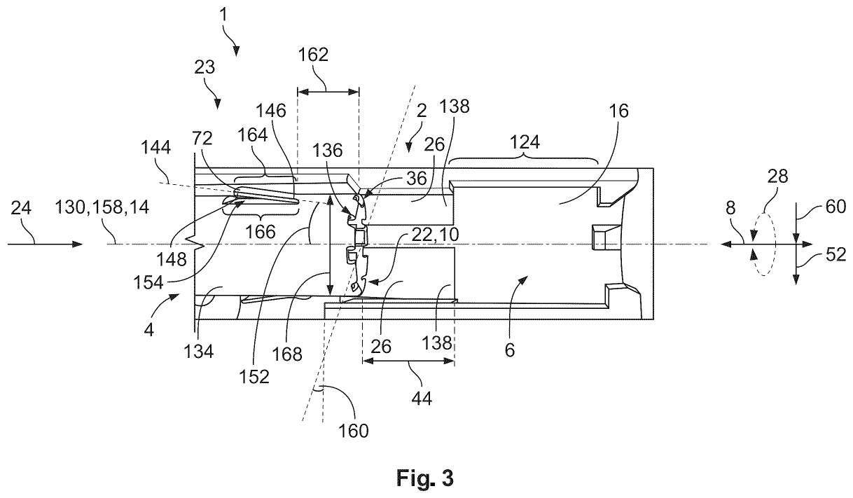

FIG. 3 a schematic perspective view of a contact assembly according to a possible embodiment before the contact element is inserted;

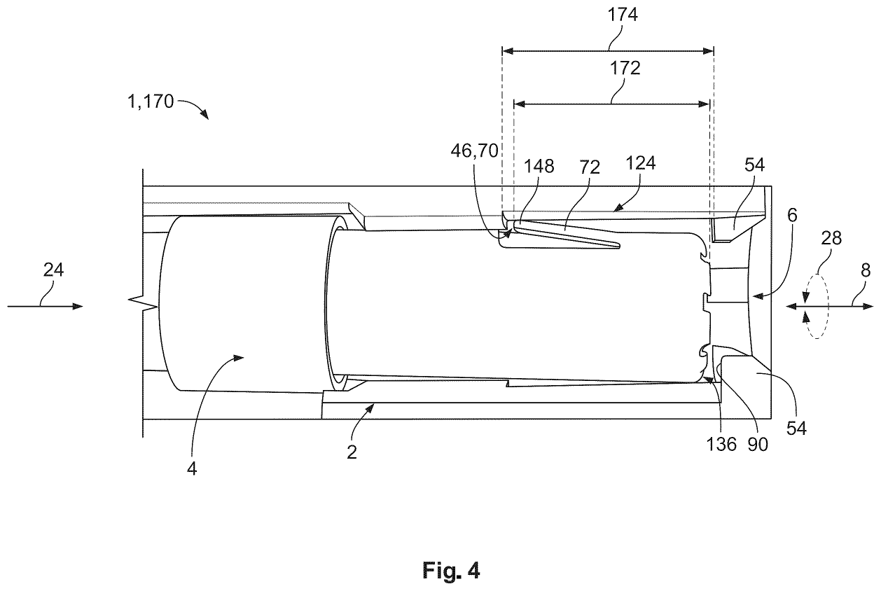

FIG. 4 a schematic perspective view of a contact assembly according to a possible embodiment in the latched state;

In the following, the structure of a contact assembly 1 is first explained with reference to FIGS. 1 and 2.

The contact assembly 1 has a housing 2 and a contact element 4.

The housing 2 has a substantially cylindrical through-opening 6, which extends along an axial direction 8 from a first housing end 10 to a second housing end 12. A longitudinal axis 14 of the through-opening 6 extends along the axial direction 8.

The through-opening 6 has a cylindrical wall 16, which is part of the housing 2. Circular end faces 18 of the cylindrical through-opening 6 are located both at the first housing end 10 and at the second housing end 12. A first end face 20 of the through-opening 6, which is arranged at the first housing end 10, is provided as an access opening 22, through which the contact element 4 can be inserted into the through-opening 6 along the axial direction 8. The insertion 23 of the contact element 4 into the through-opening 6 can take place along an insertion direction 24, which extends along the axial direction 8 away from the first housing end 10 and towards the second housing end 12.

The housing 2 may further provide at least one base 26, which may be formed by the wall 16 of the through-opening 6. Preferably, the housing 2 has a plurality of bases 26 which are arranged next to one another in a circumferential direction 28. In particular, bases 26 adjacent to one another in the circumferential direction 28 can be separated from one another by a recess 30. In this case, two adjacent bases 26 are spaced apart by a distance 32 in the circumferential direction 28. At the same time, a width 34 in the circumferential direction 28 of the recess 30 corresponds to the distance 32 in the circumferential direction 28 between two adjacent bases 26.

The bases 26 have a hollow cylindrical segmental shape with a first end face 36 and a second end face 38. The end faces 36, 38 are arranged parallel to each other and perpendicular to the axial direction 8. The first end face 36 of the base 26 lies at the first housing end 10. In particular, a plane 40 of the first end face 36 of the base 26 lies in a plane 42 of the first end face 20 of the through-opening 6. The second end face 38 of the base 26 is spaced apart from the first end face 36 of the base 26 by a base width 44 in the axial direction 8. The second end face 38 of the base 26 is located at a point in the axial direction 8, which lies between the first housing end 10 and the second housing end 12 in the axial direction 8.

The contact assembly 1 provides at least one latching surface 46. The at least one latching surface 46 is arranged in the through-opening 6 and extends along the circumferential direction 28. In the embodiment according to FIG. 1, the second end faces 36 of the bases 26 are provided as latching surfaces 46. The latching surfaces 46 can thus be formed by the wall 16 of the through-opening 6.

The latching surfaces 46 need not be formed by bases 26, but can be formed by an end 48 of a rebound 50 pointing towards the first housing end 10. This is explained briefly below with reference to FIG. 2. In particular, the rebound 50 may spring back outwards 52 in a radial direction. The rebound 50 extends in the axial direction 8 from the latching surface 46 to between two adjacent touch protection elements 54. In this case, a rebound 50 merges into a gap 56 located between two adjacent touch protection elements 54.

Rebounds 50 adjacent in the circumferential direction 28 can be separated from one another by protrusions 58. In particular, the protrusions 58 can protrude inwards 60 in a radial direction. The protrusions 58 extend in the axial direction 8 from a latching surface 46 to a touch protection element 54. In a region 62 between the first housing end 10 and the latching surfaces 46, the protrusions 58 can be united in the circumferential direction 28 to form an annular protrusion 64. The annular protrusion 64 extends along the axial direction 8 from the first housing end 10 to the latching surfaces 46.

The following explanations again refer to the embodiment shown in FIG. 1.

The latching surfaces 46 have a width 66 in the circumferential direction 28, which can be the same for all latching surfaces 46. The surface normals 68 of the latching surfaces 46 extend along the axial direction 8 and point towards the second housing end 12. In particular, the surface normals 68 of the latching surfaces 46 extend along the insertion direction 24. The latching surfaces 46 are spaced apart from the second housing end 12 in the axial direction 8. The latching surfaces 46 are provided to come into contact with complementarily configured contact surfaces 70 of latching protrusions 72 of the contact element 4. In this way, for example, a form-fit connection can be established to prevent relative movement along the axial direction 8 between contact element 4 and housing 2.

In order to enable good contact between both the contact surfaces 74 of the latching protrusions 72 of the contact element 4 and the latching surfaces 46, the latching surfaces 46 can in particular be planar planes 74. The latching surfaces 46 shown in FIG. 1 lie in a common latching surface plane 76, which extends perpendicular to the axial direction 8. In particular, a normal axis of the latching surface plane 78 extends along the axial direction 8 and along the insertion direction 24.

At the second housing end 12, at least one touch protection element 54, in a preferred embodiment a plurality of touch protection elements 54, is arranged, which are arranged next to each other and spaced apart from each other in the circumferential direction 28. The one touch protection element 54 or the plurality of touch protection elements 54 form a touch protection 80.

The touch protection elements 54 can have the shape of an inclined truncated pyramid 82. The touch protection elements 54 have a ground area 84, a top surface 86, two side surfaces 88, a first end face 90 and a second end face 92. The ground area 84 of a touch protection element 54 lies in the plane of the wall 16 of the through-opening 6. The top surface 86 of a touch protection element 54 lies parallel to the ground area 84 of a touch protection element 54. The ground area 84 includes those points 94 at which a touch protection element 54 protrudes furthest in the radial direction inwards 60 into the through-opening 6.

The first end face 90 of a touch protection element 54 extends at right angles to the axial direction 8. A normal axis 96 of the first end face 90 extends along the axial direction 8 and points towards the first housing end 10. The second end face 92 of a touch protection element 54 represents a ramp 98 pointing away from the first housing end 10. The ramp 98 can be planar or have a curved shape, for example that of a cylindrical shell segment. The ramp 98 has a normal axis 100 which is inclined relative to the axial direction 8 and a radial direction 102. The radial direction 102 extends perpendicular to the axial direction 8 and to the circumferential direction 28. In particular, the normal axis 100 of the ramp 98 points away from the first housing end 12.

A touch protection element 54 also has a cross-sectional area 104 that is parallel to the ground area 84 and the top surface 86. In particular, the cross-sectional area 104 lies in the radial direction 102 between the ground area 84 and the top surface 86. The cross-sectional area 104 becomes smaller in the radial direction inwards 60. As a result, a width 106 in the axial direction 8 of the touch protection element 54 becomes smaller in the radial direction inwards 60. The width 106 in axial direction 8 of a touch protection element 54 represents the distance in axial direction 8 between the first end face 90 and the second end face 92 of a touch protection element 54. The largest cross-sectional area 108 is located at the ground area 85 of a touch protection element 54, the smallest cross-sectional area 110 is located at the top surface 86 of a touch protection element 54.

The touch protection elements 54 are attached to the wall 16 of the through-opening 6 and protrude inwards 60 in the radial direction. In particular, the touch protection elements 54 can be formed monolithically with the housing 2 or the through-opening 6. A gap 112 can be arranged in each case between touch protection elements 54 adjacent in the circumferential direction 28. Due to the gaps 112, adjacent touch protection elements 54 are spaced apart by a distance 114 in the circumferential direction 28. The gaps 112 have a width 116 in the circumferential direction 28.

Longitudinal axes 118 of the gaps 112 extend along the axial direction 8 and at the point 120 in the circumferential direction 28 where the gaps 112 have half their width 116 in the circumferential direction 28.

At least some of the latching surfaces 46 are located in the extension of at least one gap 112, so that the gaps 112 and the latching surfaces 46 are flush in the axial direction 8. In the exemplary embodiment according to FIG. 1, a longitudinal axis 122 of a base 26 and the surface normal 68 of a latching surface 46, which is arranged on the respective base 26, extend along the axial direction 8 and along the longitudinal axis 118 of a gap 112. The width 45 in the circumferential direction 28 of the base 26 or the width 66 in the circumferential direction 28 of the latching surfaces 46 corresponds here to the width 116 in the circumferential direction 28 of a gap 112, which is arranged in axial extension to the base 26 or to the latching surface 46.

The housing 2 further includes an annular depression 124 located between the bases 26 and the second housing end 12. In particular, the annular depression 124 can extend in the axial direction 8 from the second end faces 38 of the bases 26 to the first end faces 90 of the touch protection elements 54 arranged in the circumferential direction 28. The annular depression 124 can thereby extend between two adjacent touch protection elements 54. In this case, the gap 112 between two adjacent touch protection elements 54 and the annular depression 124 merge into one another, preferably continuously.

In addition, the annular depression 124 can extend between two adjacent bases 26. In this case, the recesses 30 between two adjacent bases 26 and the annular depression 124 merge into one another. In particular, the transition between the recesses 30 between two adjacent bases 26 and the annular depression 124 can be without jumps. In this case, an inner diameter 126 of the through-opening 6 in the annular depression 124 is the same as an inner diameter 128 of the through-opening 6 in the recesses 128.

The contact assembly 1 further comprises the contact element 4. The contact element 4 has a substantially cylindrical shape extending along a longitudinal axis 130 of the contact element 4. The contact element 4 has a diameter 132 that is sufficiently small to allow the contact element 4 to be inserted into the through-opening 6 of the housing 2. An outer surface 134 of the contact element 4 also has a substantially cylindrical shape, which may be complementary to the wall 16 of the through-opening 6 of the housing 2. The contact element 4 can be a socket, for example.

At one axial end, the contact element 4 has a front end face 136. During insertion 23, the contact element 4 is oriented such that the contact element 4 enters the through-opening 6 of the housing 2 with the front end face 136 first.

The contact element 4 provides at least one latching protrusion 72, which has a width 140 in the circumferential direction 28. The at least one latching protrusion 72 is provided for form-fit engagement with at least one complementarily configured latching surface 46 of the housing 2. Preferably, the contact element 4 has a plurality of latching protrusions 72 arranged next to one another in the circumferential direction 28. In particular, the latching protrusions 72 arranged next to one another in the circumferential direction 28 can be equally spaced apart in the circumferential direction 28 and have the same width 140 in the circumferential direction 28.

In FIGS. 1 to 4, the latching protrusions 72 are exemplarily configured as latching fingers 144. However, numerous other configurations of the latching protrusions are possible, for example as a locking latch or locking spring.

The latching protrusions 72 extend along a longitudinal axis 144 from a basis 146 to a free end 148. In an unloaded state 150, an angle 152 exists between the longitudinal axes 144 of the latching protrusions 72 and the longitudinal axis 130 of the contact element 4.

The bases 146 of the latching protrusions 72 are preferably connected to the outer surface 134 of the contact element 4 in a material-locking manner. In particular, the latching protrusions 72 can be formed monolithically with the contact element 4. In an unloaded state 150, the free ends 148 of the latching protrusions 72 are spaced apart from the outer surface 134 of the contact element 4 in the radial direction 102. The latching protrusions 72 are provided to be deflected or elastically deformed inwardly 60 in the radial direction. If the latching protrusions 72 are maximally deflected inwardly 60 in the radial direction, the longitudinal axes 144 of the latching protrusions 72 extend along the longitudinal axis 130 of the contact element 4. In this state, the latching protrusions 72 fit into trough-shaped depressions 154 that are complementary in shape to the latching protrusions 72 and are recessed into the outer surface 134 of the contact element 4.

The free ends 148 of the latching protrusions 72 have contact surfaces 70 that are oriented perpendicular to the longitudinal axis 144 of the latching protrusions 72. In particular, the normal axes 156 of the contact surfaces 70 of the latching protrusions 72 extend along the longitudinal axis 144 of the latching protrusions 72. The more the latching protrusions 72 are deflected inwards 60 in the radial direction, the smaller the angle 152 between the longitudinal axis 144 of the latching protrusions 72 and the longitudinal axis 130 of the contact element 4. The contact surfaces 70 of the latching protrusions 72 are adapted to come into contact with the latching surfaces 46 of the housing 2. In this way, a form-fit connection can be realized between the latching protrusions 72 of the contact element 4 and the latching surfaces 46 of the housing 2.

In the following, the insertion 23 of the contact element 4 into the housing 2 is described with reference to FIGS. 3 and 4.

At the beginning of the insertion 23, the contact element 4 is positioned in axial extension of the through-opening 6 of the housing. The front end face 136 of the contact element 4 lies in the access opening 22 at the first housing end 10. The longitudinal axis 130 of the contact element 4 extends along a central axis 158 of the housing 2, along the longitudinal axis 14 of the through-opening 6 and along the insertion direction 24.

During insertion 23, the contact element 4 can have any angular position 160 in the circumferential direction 28 relative to the through-opening 6. The contact element 4 can be inserted into the through-opening 6 of the housing 2 in any desired angular position 160 in the circumferential direction 28, as long as the longitudinal axis 130 of the contact element 4 extends along the longitudinal axis 14 of the through-opening 6 and along the insertion direction 24.

For insertion 23, the contact element 4 is pushed along the insertion direction 24 through the access opening 22 into the through-opening 6 of the housing 2. In the process, the front end face 136 of the contact element 4 is moved in the direction of the second housing end 12. After the contact element 4 has been inserted into the through-opening 6 of the housing 2 along the insertion direction 24 by a distance 162 in the axial direction 8 between the front end face 136 and the bases 146 of the latching protrusions 72, the bases 146 of the latching protrusions 72 first come into contact with the first end faces 36 of the bases 26. The points at which the first end faces 36 of the bases 26 come into contact with the latching protrusions 72 are referred to as contact points 164.

Upon further insertion 23 of the contact element along the direction of insertion, the contact points 164 move along the longitudinal axes 144 of the latching protrusions 72 from the bases 146 of the latching protrusions 72 to the free ends 148 of the latching protrusions 72. As a result, the latching protrusions 72 are deflected inwardly 60 in the radial direction. This reduces the angle 152 between the longitudinal axes 144 of the latching protrusions 72 and the longitudinal axis of the contact element 4, so that the latching protrusions 72 move towards the complementarily shaped trough-shaped depressions 154 in the outer surface 134 of the contact element 4. When the contact point 164 has arrived at the free end 148 of a latching protrusion 72, the latching protrusions 72 cannot be deflected any further inwardly 60 in the radial direction by the first end faces 36 of the bases 26. In this state, the latching protrusions 72 are completely accommodated in the trough-shaped depressions 154 in the outer surface 134 of the contact element 4. Then the diameter 165 of the contact element 4 in a recessed area 166 extending along the axial direction 8 corresponds to the diameter 168 of the contact element 4 at the front end face, so that the contact element 4 can be pushed further into the through-opening 6.

After the contact element has been pushed further along the insertion direction 24 by the base width 44, the free ends 148 of the latching protrusions 72, which are deflected inwards 60 in the radial direction, are in contact with second ends 138 of the base 26. If the contact element 4 is now pushed further along the insertion direction 24, the latching protrusions 72, which are deflected inwards 60 in the radial direction, can no longer be pressed by the base 26 into the trough-shaped shaped depressions 154 of the contact element 4. Consequently, the elastically deformed latching protrusions 72 snap outwards 52 in the radial direction due to their restoring force. In this case, the latching protrusions 72 are accommodated in the annular depression 124 in the wall 16 of the housing 2.

In this state, the contact element 4 is latched inside the housing 2.

If the contact element 4 is moved further along the insertion direction 24 in the latched state 170, the front end face 136 of the contact element 4 strikes against the first end faces 90 of the touch protection elements 54, which are arranged at the second housing end 12. This limits further movement of the contact element 4 along the insertion direction 24.

If the contact element 4 is moved in the latched state 170 against the insertion direction 24, the contact surfaces 70, which are located at the free ends 148 of the latching protrusions 72, strike against the latching surfaces 46 of the housing 2. This limits movement against the insertion direction 24.

If a distance 172 in axial direction 8 between the free ends 148 of the latching protrusions 72 and the front end face 136 of the contact element 4 is smaller than a width 174 of the annular depression 124, the contact element 4 latched inside the housing 2 has play in axial direction 8. Nevertheless, the movement in axial direction 8 of the contact element 4 relative to the housing 2 is limited as described above.

In the latched state 170, the contact element 4 can be rotated in the through-opening 6 along the circumferential direction 18 as desired. In each angular position 160 in the circumferential direction 28 between the contact element 4 and the through-opening 6, it is ensured that the contact element 4 is still secured against movement in the axial direction 8. In particular, it is ensured that at each angular position 160 of the contact element 4, at least one latching protrusion 72 of the contact element 4 is latched with at least one latching surface 46 of the housing 2. Furthermore, a contact element 4 can have at least one latching protrusion 72 in each angular position 160 in the circumferential direction 28, which abuts against a latching surface 46 over its entire width 140 in the circumferential direction 28 or is latched with a latching surface 46.

### REFERENCE SIGNS

1 contact assembly
2 housing
4 contact element
6 through-opening
8 axial direction
10 first housing end
12 second housing end
14 longitudinal axis of the through-opening
16 wall
18 end faces of the through-opening
20 first end face of the through-opening
22 access opening
23 insertion
24 insertion direction
26 base
28 circumferential direction
30 recess
32 distance in circumferential direction between adjacent bases
34 width in circumferential direction of the recess
36 first end face of the base
38 second end face of the base
40 plane of the first end face of the base
42 plane of the first end face of the through-opening
44 base width in the axial direction
45 width in the circumferential direction of the base
46 latching surface
48 end of a rebound
50 rebound
52 radial direction outwards
54 touch protection element
56 gap between two touch protection elements
58 protrusion
60 radial direction inwards
62 area between the first housing end and the latching surfaces
64 annular protrusion
66 width in the circumferential direction of the latching surfaces
68 surface normals of the latching surfaces
70 contact surfaces of the latching protrusions
72 latching protrusion
74 planar plane
76 latching surface plane
78 normal axis of the latching surface plane
80 touch protection
82 inclined truncated pyramid
84 ground area of the touch protection element
86 top surface of the touch protection element
88 side surfaces of the touch protection element
90 first end face of the touch protection element
92 second end face of the touch protection element
94 points protruding furthest in the radial direction inwards
96 normal axis of the first end face of the touch protection element
98 ramp
100 normal axis of the ramp
102 radial direction
104 cross-sectional area of the touch protection element
106 width in the axial direction of the touch protection element
108 largest cross-sectional area of the touch protection element
110 smallest cross-sectional area of the touch protection element
112 gap
114 distance in the circumferential direction between adjacent touch protection elements
116 width in the circumferential direction of a gap
118 longitudinal axis of a gap
120 point in the circumferential direction
122 longitudinal axis of a base
124 annular depression
126 inner diameter of the through-opening in the annular depression
128 inner diameter of the through-opening in the recesses
130 longitudinal axis of the contact element
132 diameter of the contact element
134 outer surface of the contact element
136 front end face of the contact element
138 second ends of the bases
140 width in the circumferential direction of a latching protrusion
142 latching finger
144 longitudinal axis of the latching protrusions
146 basis
148 free end
150 unloaded state
152 angle
154 trough-shaped depressions
156 normal axes of the contact surfaces
158 central axis of the housing
160 angular position
162 distance between first end face of the base and the bases
164 contact points
165 diameter of the contact element in the recessed area
166 recessed area
168 diameter of the contact element at the front end face
170 latched state
172 distance between free ends and front end face
174 width of the annular depression

1. A contact assembly for electrical HV connections, having a housing with touch protection which has a through-opening extending from a first housing end of the housing to a second housing end of the housing which is spaced apart from the first housing end along an axial direction, wherein the housing has at least one radially inwardly protruding touch protection element at the second housing end and has, in the through-opening, at least one latching surface extending in a circumferential direction around the axial direction which has a surface normal directed towards the second housing end; having a contact element which can be inserted from the first housing end into the through-opening towards the second housing end in any desired angular position around the axial direction, wherein at least one latching protrusion of the contact element latches with the at least one latching surface in each of the desired angular positions when the contact element is inserted into the through-opening.

2. The contact assembly according to claim 1, wherein the through-opening has a plurality of latching surfaces spaced apart from one another in the circumferential direction and the contact element has a plurality of latching protrusions arranged next to one another in the circumferential direction; and wherein, when the contact element is latched in the housing, at least one latching protrusion abuts against a latching surface in each angular position of the contact element relative to the housing over its entire width extending in the circumferential direction.

3. The contact assembly according to claim 2, wherein the latching surfaces and the latching protrusions have at least one of the following differences:
the width in the circumferential direction of at least some of the plurality of latching surfaces differs from the width in the circumferential direction of at least some of the plurality of latching protrusions;
the number of latching surfaces differs from the number of latching protrusions;
the distance in the circumferential direction between at least some latching protrusions of the plurality of latching protrusions, the at least some latching protrusions being adjacent in the circumferential direction, differs from the distance in the circumferential direction between at least some touch protection elements adjacent in the circumferential direction.

4. The contact assembly according to claim 2, wherein in the circumferential direction adjacent touch protection elements of the plurality of touch protection elements are separated from each other by a gap; and wherein at least some of the plurality of latching surfaces are located in the axial direction in extension of at least one gap each.

5. The contact assembly according to claim 4, wherein the width of a latching surface in the circumferential direction is at most as large as the width of the gap in the circumferential direction.

6. The contact assembly according to claim 2, wherein at least one latching protrusion of the plurality of latching protrusions is latched with at least two latching surfaces when the contact element is inserted into the housing.

7. The contact assembly (1) according to claim 1, wherein a latching surface forms the end, facing the second housing end, of a base extending in the axial direction from the first to the second housing end.

8. The contact assembly according to claim 7, wherein the base is flush in axial direction with a gap between two touch protection elements adjacent in circumferential direction.

9. The contact assembly according to claim 7, wherein the housing comprises a plurality of bases and bases adjacent to each other in the circumferential direction are separated from each other by a recess.

10. The contact assembly according to claim 7, wherein an annular depression is located between the bases and the second housing end.

11. The contact assembly according to claim 5, wherein the latching surface is formed by the end of a rebound pointing towards the first housing end, which rebound extends in the axial direction from the latching surface to between two adjacent touch protection elements.

12. The contact assembly according to claim 11, wherein rebounds adjacent in the circumferential direction are separated from one another by a protrusion and the protrusion extends in the axial direction from a latching surface to a touch protection element.

13. The contact assembly according to claim 11, wherein the width of the latching protrusions in the circumferential direction is smaller than the width of the latching surface in the circumferential direction.

14. The contact assembly according to claim 1, wherein the housing is made by injection molding.
